(19) United States
(12) Patent Application Publication
(10) Pub. No.: US 2008/0048460 A1
(43) Pub. Date: Feb. 28, 2008

(54) CLAMPING ASSEMBLY FOR A MANHOLE COVER

(75) Inventors: Robert C. Brady, Muskegon, MI (US); Aidan R. Brady, Muskegon, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: GMI Composites Inc., Muskegon, MI (US)

(21) Appl. No.: 11/845,549

(22) Filed: Aug. 27, 2007

Related U.S. Application Data
(60) Provisional application No. 60/840,253, filed on Aug. 25, 2006.
(60) Provisional application No. 60/936,152, filed on Jun. 18, 2007.

(51) Int. Cl. B65D 45/24; E05D 11/10

(52) U.S. Cl. 292/256.71; 16/350; 292/336.3

(57) ABSTRACT

A screw cap assembly for clamping a cover in an opening includes a threaded rod adapted to engage the cover and a clamp threadably connected to the threaded rod. A retainer is adapted to support the threaded rod and to limit the range of movement of the clamp along the threaded rod. Rotational movement of the threaded rod causes the clamp to rotate and travel toward the cover until it engages a first abutment of the retainer, which prevents further rotational movement of the clamp, such that only movement toward the cover in a direction parallel the threaded rod is permitted. Rotational movement of the threaded rod in an opposite direction causes the clamp to rotate and travel away from the cover until the clamp engages a second abutment of the retainer adapted to engage the clamp to prevent further movement of the clamp away from the cover.

### CROSS REFERENCE TO RELATED APPLICATIONS

The present application claims the benefit of U.S. provisional applications, Ser. No. 60/840,253, filed Aug. 25, 2006, and Ser. No. 60/936,152, filed Jun. 18, 2007, by Brady et al. for REINFORCED COMPOSITE MANHOLE COVER AND COMPONENTS THEREOF, which are hereby incorporated herein by reference in their entireties.

### FIELD OF THE INVENTION

The present invention relates generally to clamp mechanisms for manhole covers, in particular such mechanisms used to lock and/or seal the covers.

### BACKGROUND OF THE INVENTION

A manhole cover provides a protective covering for an opening into a sewer, a conduit, an underground tunnel or the like. The cover functions to keep trespassers and/or vandals out, to prevent the contents of a sewer or tunnel from exiting the opening and to provide a surface over which vehicles may drive, for example. Manhole covers presently known in the art may include locks to keep them in place; however, because of the significant cost, such locks are not often used. Also, some manhole covers require a two inch diameter opening in order to incorporate such a lock. As a result, manhole covers generally do not include locks and may therefore be removed, such that access may be obtained to the underlying opening or a vehicle driving over the opening may be damaged.

### SUMMARY OF THE INVENTION

Latching and clamping or sealing assemblies are provided for sealing or clamping or latching a cover, such as a manhole cover or manhole cover assembly, in a desired position over an opening.

A screw cap assembly for clamping a cover over an opening includes a threaded rod adapted to engage the cover and a clamp threadably connected to the threaded rod. The screw cap assembly also includes a retainer adapted to support the threaded rod and to limit the range of movement of the clamp along the threaded rod. Rotational movement of the threaded rod causes the clamp to rotate and travel toward the cover until it engages a first abutment of the retainer, which prevents further rotational movement of the clamp, such that only movement toward the cover in a direction parallel the threaded rod is permitted. Rotational movement of the threaded rod in an opposite direction causes the clamp to rotate and travel away from the cover until the clamp engages a second abutment of the retainer adapted to engage the clamp to prevent further movement of the clamp away from the cover.

The screw cap assembly may include a spring mounted to the threaded rod, such that the spring is biased to urge the clamp toward the second abutment of the retainer.

Optionally, the clamp includes an aperture adapted to receive the threaded rod therethrough and includes a flanged edge adapted to engage a structure adjacent to the opening being covered. The clamp may be adapted to create a sealed connection between the cover and the opening.

Optionally, the screw cap assembly includes a connection element adapted to engage the cover and support the threaded rod at the cover. A nut may be threadably connected to the connection element for retaining the retainer to the connection element.

Further, the retainer may include at least two extensions adapted to protect the threaded rod and the clamp.

The screw cap assembly may be formed from a polymer. The cover being clamped or sealed or latched may be a unitary manhole cover or a manhole cover assembly having at least two components, either of which may also be formed from a polymer.

According to another embodiment, a screw cap assembly for clamping or sealing a cover over an opening includes a cap adapted to drop into or be positioned in an aperture in a cover and a retainer adapted to secure the cap in the aperture. At least one tie rod is connected to the retainer, and a traveling member is guided by the at least one tie rod. A threaded bolt threadably engages the traveling member, such that rotation of the threaded bolt by a head or head portion causes movement of the traveling member along the tie rod or tie rods. A clamp is connected to the traveling member, wherein upward movement of the traveling member toward the cover causes the threaded bolt to engage an aperture of the clamp, which causes the clamp to pivot to engage an edge of the opening to retain the cover in the opening. Rotation of the threaded bolt in an opposite direction causes downward movement of the traveling member away from the cover, which causes the threaded bolt to disengage the aperture in the clamp, which allows the clamp to pivot away from and/or disengage the edge of the opening. Thus, the cover may be removed from the opening.

Optionally, the traveling member may be snapped onto the tie rod or tie rods. The clamp may be snapped onto the traveling member. The aperture in the cover may have a diameter of one inch.

Further, the clamp may create a sealed connection between the cover and the opening. The screw cap assembly may be formed from a polymer and may be used with a unitary manhole cover or a manhole cover assembly, either of which may also be formed from a polymer.

According to yet a further embodiment, a snap retention assembly for retaining a cover over an opening includes a living hinge member having two support elements, which are fastened to the cover, and a latch member. The latch member includes a retaining end, which is adapted to engage an edge of the opening, and an actuation end. The latch member is biased in a latched position, in which the retaining end engages the edge of the opening. Accordingly, the snap retention assembly also includes an actuator, which is adapted to engage the actuation end of the latch member to disengage the retaining end from the edge of the opening, such that the cover may be released from the opening.

The snap retention assembly may include a cup element, which is adapted to protect portions of the living hinge member and the actuator that are positioned below the cover.

Optionally, the actuator may include a removable handle having at least one cross member adapted to engage the actuation end of the latch member when the removable handle is turned.

Further, a covering element may be positioned at an upper surface of the cover. The covering element may be adapted to cover one or more apertures in the cover, which are provided to accommodate the snap retention assembly.

Optionally, the support elements of the living hinge member may be snapped onto the cover.

The snap retention assembly may be formed from a polymer. Further, the snap retention assembly may be used with a manhole cover, which may also be formed from a polymer.

These and other objects, advantages, purposes and features of the present invention will become apparent upon review of the following specification in conjunction with the drawings.

### BRIEF DESCRIPTION OF THE DRAWINGS

FIG. 1 is a perspective view of a screw cap assembly in accordance with the present invention;

FIG. 2 is a sectional side elevation of the screw cap assembly of FIG. 1;

FIG. 3 is a top plan view of a retainer of the screw cap assembly of FIGS. 1 and 2;

FIG. 4 is a side elevation of the retainer of FIG. 3;

FIG. 5 is a top plan view of a clamp of the screw cap assembly of FIGS. 1 and 2;

FIG. 6 is a side elevation of the clamp of FIG. 5;

FIG. 7 is an upper perspective view of another screw cap assembly according to an aspect of the present invention;

FIG. 8 is a sectional side elevation of the screw cap assembly of FIG. 7;

FIG. 9 is a perspective view of a manhole cover assembly with a screw cap assembly taken from the top and side, with the screw cap assembly in both a clamped and released position;

FIG. 10 is a perspective view of the manhole cover assembly with the screw cap assembly of FIGS. 7-9, taken from the bottom and side with the screw cap assembly in a clamped position;

FIG. 11 is a perspective view of a snap retention assembly according to another aspect of the present invention;

FIG. 12 is a perspective sectional view of the snap retention assembly of FIG. 11 with a manhole cover;

FIG. 13 is a perspective view of a manhole cover with the snap retention assembly of FIG. 12 taken from the top and side, illustrating a removable handle in an in-use position;

FIG. 14 is a perspective view of a manhole cover with the snap retention assembly of FIG. 13 taken from the bottom and side;

FIG. 15 is a sectional side elevation of a manhole cover with the snap retention assembly of FIG. 11; and

FIG. 16 is the same view as FIG. 15 with a removable handle in the in-use position.

### DESCRIPTION OF THE PREFERRED EMBODIMENTS

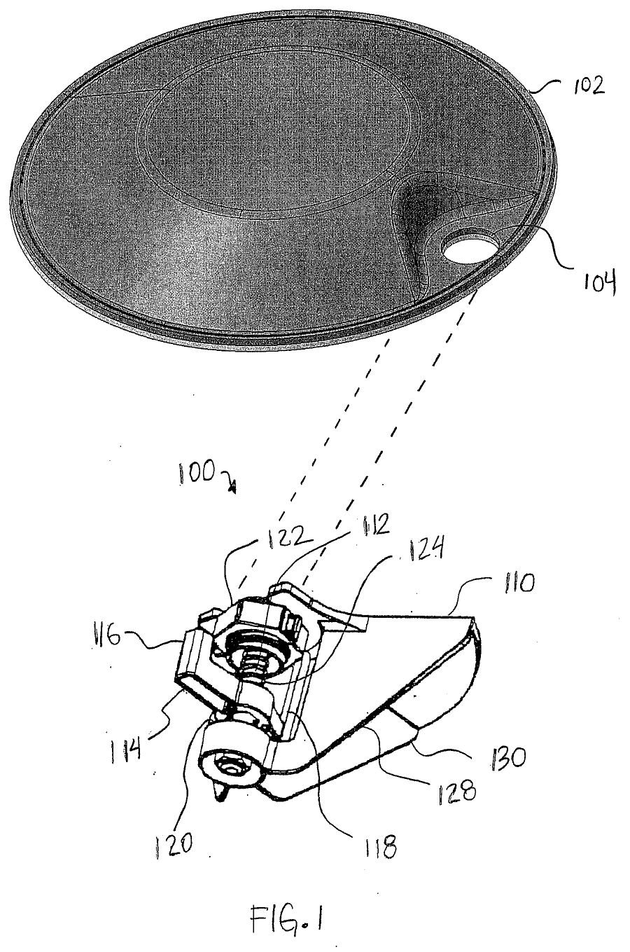

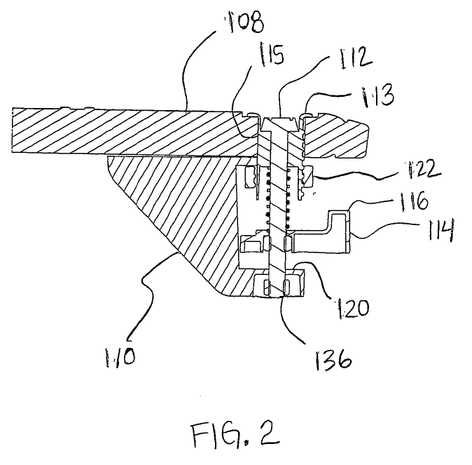

Referring now to the drawings and the embodiments illustrated therein, a screw cap assembly 100 is provided for clamping a cover 102, such as a manhole cover or the like, over an opening (not shown). Screw cap assembly 100 is adapted to be inserted in the aperture 104 of cover 102, for example (FIG. 1). Screw cap assembly 100 includes a threaded rod or bolt 112 adapted to engage the cover and a clamp 114 threadably connected to threaded rod 112 (FIGS. 1 and 2). Screw cap assembly 100 also includes a retainer 110 connected to threaded rod 112 and adapted to support threaded rod 112. To facilitate the connection of clamp 114 to threaded rod 112, clamp 114 includes an aperture 126, through which threaded rod is positioned and threadably connected (FIGS. 2 and 5). Retainer 110 is connected to threaded rod 112 at least two points, such that clamp 114 is positioned along threaded rod 112 between the two points of contact of retainer 110 and threaded rod 112.

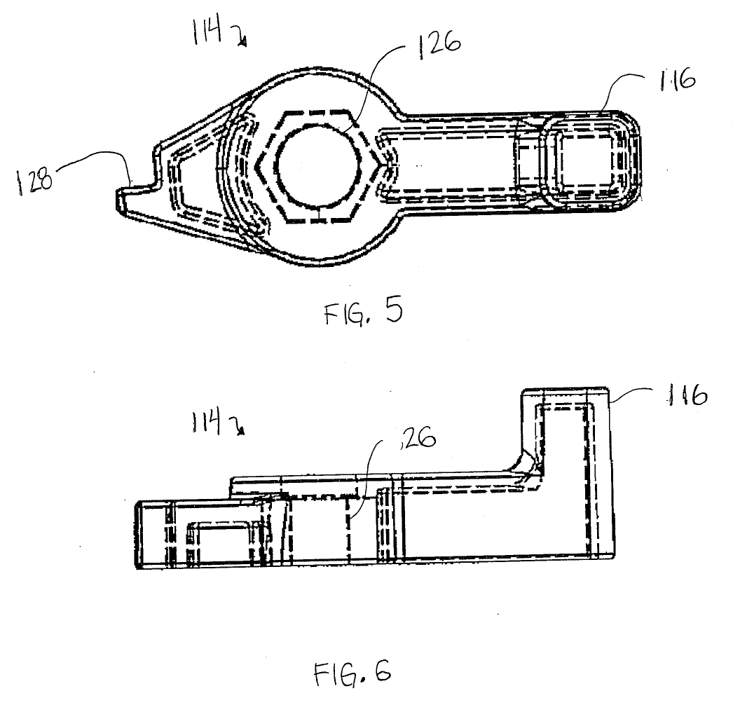

Directional rotational movement of threaded rod 112, such as in the clockwise direction, causes clamp 114 to rotate and travel upward and toward the cover until the clamp engages a first abutment 118 of retainer 110, which prevents further rotational movement of clamp 114 in the clockwise direction. Once clamp 114 strikes first abutment 118, further rotational movement of threaded rod 112 only results in movement of clamp 114 toward the cover in a direction parallel to threaded rod 112. Clamp 114 travels toward the cover until it engages a structure adjacent to the opening, such as a ledge or lip or the like, to clamp the cover in the opening. Clamp 114 may include a flanged edge 116 adapted to engage a structure adjacent to the opening to assist in clamping the cover in the opening (FIG. 6).

Rotational movement of threaded rod 112 in an opposite direction causes clamp 114 to rotate away from first abutment 118, such that clamp 114 is permitted to travel downward and away from the cover, until the clamp engages a second abutment 120 of retainer 110, which prevents further downward movement of clamp 114. At this position, the cover has been released from clamp 114.

Thus, retainer 110 functions to limit the range of motion of clamp 114. In the illustrated embodiment, first abutment 118 is formed as a ridge along the surface of retainer 110 (FIG. 1). Clamp 114 includes an arm 128 adapted to engage first abutment 118, which prevents clamp 114 from further rotational movement in one direction. Second abutment 120 is formed as an extension from retainer 110, having an aperture therethrough to receive an end or portion of threaded rod 112. Rotational movement of clamp 114 in an opposite direction causes clamp 114 to engage second abutment 120, which prevents further movement of clamp 114 away from the cover, and also prevents clamp 114 from sliding or otherwise traveling off of threaded rod 112 (FIG. 2). Thus, first and second abutments 118, 120 of retainer 110 limit the range of motion of clamp 114 to allow clamp 114 to engage and clamp the cover to an opening, and to release the cover, without removing clamp 114 from threaded rod 112.

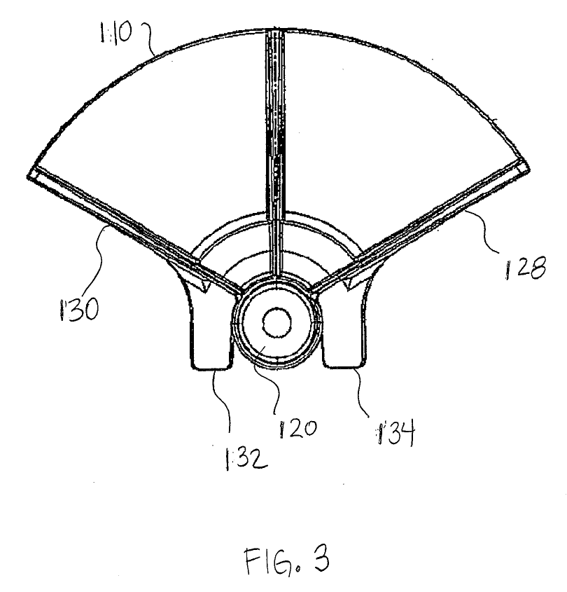

Retainer 110 may also function to protect the components of screw cap assembly 100, including threaded rod 112 and clamp 114. In the illustrated embodiment, retainer 110 includes two extensions 128, 130 which extend radially outward or away from threaded rod 112 (FIGS. 1 and 3). Extensions 128, 130 may prevent damage to threaded rod 112 and clamp 114 in the case of rolling or dropping cover 108 and may provide increased strength and rigidity to screw cap assembly 100.

To ensure that threaded rod is rotated sufficiently to establish a clamped connection between clamp 114 and the structure adjacent to the opening, resistance may be provided to urge clamp 114 away from the clamped position. For example, screw cap assembly 100 may include a spring 124 mounted to threaded rod 112 (FIG. 1). Spring 124 is biased to urge clamp 114 away from the cover, toward second abutment 120 of retainer 114. Thus, a user or operator must overcome the force of the spring and the friction created between clamp 114 and threaded rod 112 in order to establish a clamped connection between clamp 114 and the edge of the opening. Spring 124 may also function to urge clamp 114 away from the cover when clamp 114 has been released from first abutment 120.

Optionally, a connection element 113 is adapted to secure the components of screw cap assembly 100, including retainer 110 and threaded rod 112, to the cover. As shown in FIG. 2, connection element 113 includes flanged edges adapted to engage cover 108, such that connection element 113 is adapted to drop into an aperture 115 in cover 108 and is supported by cover 108. Threaded rod 112 is supported by connection element 113 and may be similarly dropped into an aperture in connection element 113.

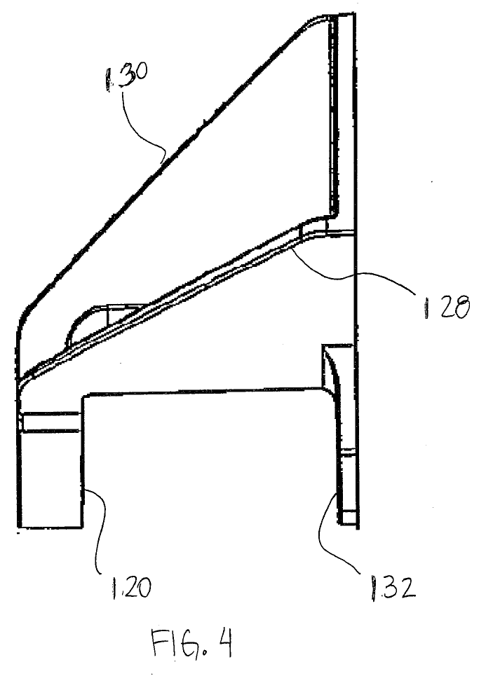

In the illustrated embodiment, retainer 110 includes two arms 132, 134 adapted to grasp or attach to connection element 113 (FIGS. 3 and 4). Optionally, screw cap assembly 100 may also include a nut 122 threadably connected to connection element 113 for securing retainer 110 to connection element 113.

Screw cap assembly may be formed from any suitable material, including a polymer or resin, which one skilled in the art would know to include nylon, urethane, polyester, epoxy, phenolic and the like. Polymers are generally lightweight, as opposed to steel or brass, which are typically used to form manhole cover clamps or locks. Such polymers may also be glass or fiber reinforced, which creates strength while maintaining the relatively light weight of the material. Fibers used to reinforce the resin include fiberglass, carbon fiber, and aramid, which is sold under the trade name Kevlar. The percentage of resin and fiber reinforcing material used in production of the manhole cover clamping assemblies varies based on the strength requirements clamping assemblies. Cover 108 may also be formed from such a reinforced polymer and may be a unitary manhole cover or a manhole cover assembly having at least two components, such as the manhole cover assemblies disclosed in U.S. patent Ser. No. ______, filed concurrently herewith by Brady et al. for a REINFORCED COMPOSITE MANHOLE COVER ASSEMBLY (Attorney Docket GMI01 P-100B), the disclosure of which is hereby incorporated herein by reference.

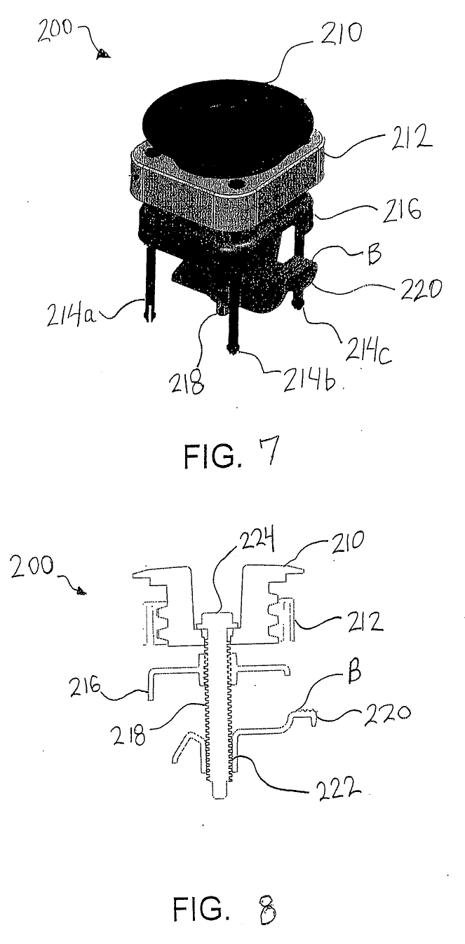

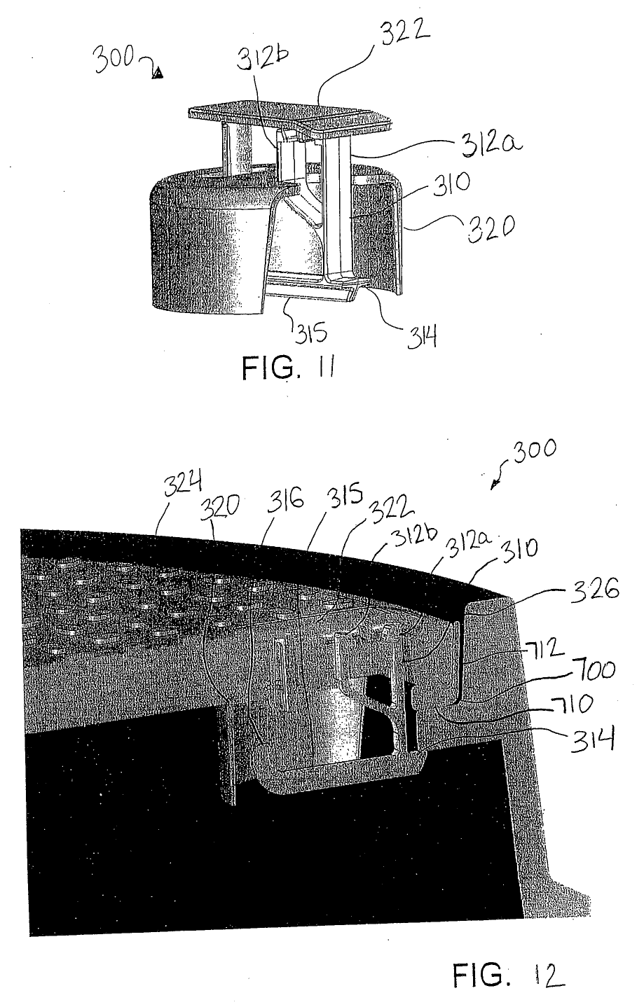

According to another embodiment, a screw cap assembly 200 includes a cap 210, a retainer 212, a plurality of tie rods 214a-d, a traveling member 216, a threaded bolt 218, and a clamp 220 (FIG. 7). As shown in FIGS. 7 and 8, cap 210 is dropped into or otherwise positioned in an opening in a cover, such as the aperture in a manhole cover assembly 10. Cap 210 is retained in the opening by retainer 212. As shown in FIG. 12, cap 210 may be threadably connected to retainer 212, which may be twisted to tighten cap 210 to the cover. However, other methods of joining or connecting retainer 212 and cap 210 may be used. As shown in FIG. 10, tie rods 214a-d are connected to retainer 212 and function to guide reciprocal movement of traveling member 216. Traveling member 216 may be connected to tie rods 214a-d by a snap connection, fastening rings, or the like.

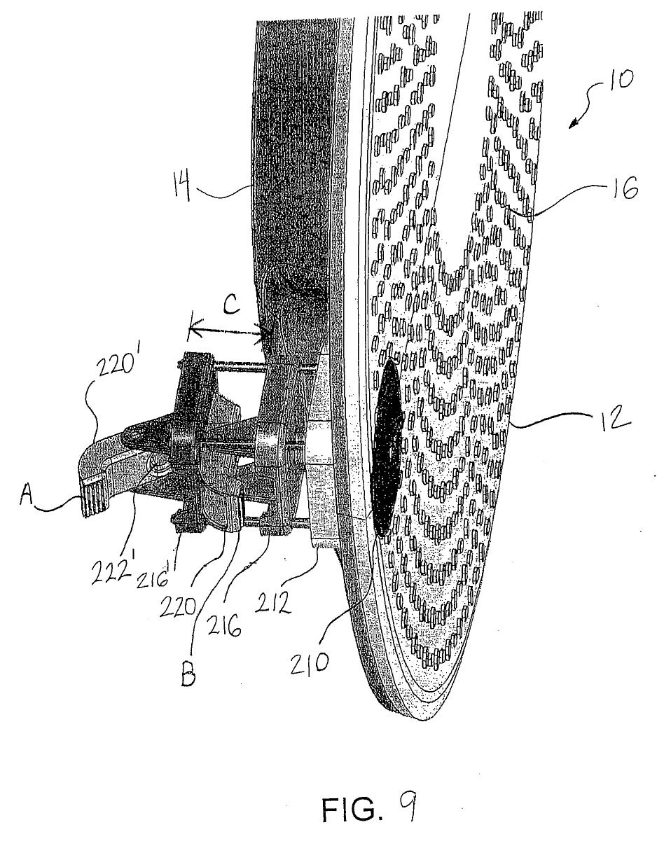

As best shown in FIG. 8, threaded bolt 218 threadably engages traveling member 216, i.e., threaded bolt is threadably connected to traveling member 216. Threaded bolt 218 includes a head 224, which is accessible from the exterior or outside of the manhole. For example, and as shown in FIG. 9, when screw cap assembly 200 is used to clamp manhole cover assembly 10 over an opening, head 224 of threaded bolt 218 is accessible from outer surface 16 of cover 12. Twisting head 224 of threaded bolt 218 causes traveling member 216 to move along tie rods 214a-d, as described above.

As shown in FIG. 9, clamp 220 is pivotally connected to traveling member 216, such as by a snap connection or the like. As shown in FIG. 8, clamp 220 includes an aperture 222 through which threaded bolt 218 may travel or extend. As best shown in FIG. 9, when aperture 222 is not engaged by threaded bolt 218, clamp 220 is oriented in a downward, generally vertical, released position A, in which the manhole cover may be released from the edge of the opening. To tighten clamp 220 to the edge of the manhole cover, head 224 is manipulated to rotate threaded bolt 218 in a direction that causes traveling member 216 to travel upward toward the edge of the opening, along tie rods 214a-d in range of motion C. As traveling member 216 travels upward, threaded bolt 218 engages an edge or inner surface of aperture 222 of clamp 220. Threaded bolt 218 continues to extend through aperture 222, which causes clamp 220 to pivot to a generally horizontal, clamped position B, as shown in FIGS. 8 and 9. In clamped position B, clamp 220 engages a portion of the opening, such as a lip or extension, thus clamping or sealing the manhole cover to the opening.

Clamp 220 may also function to secure a manhole cover over an opening in a partially pivoted, angled position. For example, if the opening does not include a lip or edge that clamp 220 may engage in a horizontal position, clamp 220 may pivot until it engages and presses against an inner edge or surface of the opening (not shown). Thus, clamp 220 may secure the cover over the opening in a partially pivoted or angled position.

To release clamp 220 from either the partially pivoted or the generally horizontal clamped position, and thus to release the cover from the opening, head 224 is manipulated to rotate threaded bolt 218 in an opposite direction than described above, which causes traveling member 216 to travel downward to a position in which threaded bolt 218 no longer engages aperture 222 of clamp 220. Thus, clamp 220 is free of threaded bolt 218 and is able to pivot down towards the generally vertical released position A, in which the cover may be released from the opening.

In FIG. 9, both released position A and clamped position B are illustrated. As described above, in clamped position B, traveling member 216 is positioned near retainer 212, and clamp 220 is shown in a generally horizontal position. In released position A, traveling member 216′ has traveled downward, and clamp 220′ has pivoted downward toward a generally vertical position.

To prevent access to head 224 of threaded bolt 218, which may be turned to loosen clamp 220 to release the manhole cover from the opening, a key-type locking device may be included to cover or otherwise prevent access to head 224 (not shown). Blocking access to head 224 prevents manipulation of traveling member 216 and, thus, clamp 220, which prevents the manhole cover from being unlocked or loosened from the opening. As an added security measure, head 224 of threaded bolt 218 may include a special or unique socket that requires a unique tool. Thus, assuming access to head 224 is obtained, the unique tool would be required to turn head 218 to manipulate clamp 220 and, therefore, to release the manhole cover from the opening.

Screw cap assembly 200 may be adapted to function with a unitary manhole cover or a manhole cover assembly having at least two components, such as the manhole cover assemblies discussed in U.S. patent Ser. No. ______, filed concurrently herewith by Brady et al. for a REINFORCED COMPOSITE MANHOLE COVER ASSEMBLY (Attorney Docket GMI01 P-100B). Screw cap assembly 200 may be incorporated or inserted into aligned apertures in a two-piece cover assembly. To accommodate screw cap assembly 200, the apertures may have a one inch diameter.

Both screw cap assembly 200 and the cover or cover assembly which it clamps over an opening may be formed from a reinforced polymer or resin, as discussed above. Because of the lightweight design of a polymeric manhole cover assembly, a securing mechanism or clamping mechanism, such as screw cap assembly 200, may be required to prevent movement of the manhole cover assembly from the opening which it covers. In addition to clamping or otherwise securing a manhole cover assembly in place, screw cap assembly 200 may function to seal or provide a sealed connection between the manhole cover assembly and the opening. A sealed connection between the cover and the opening may prevent matter, such as water or gases or the like, from entering or exiting the opening.

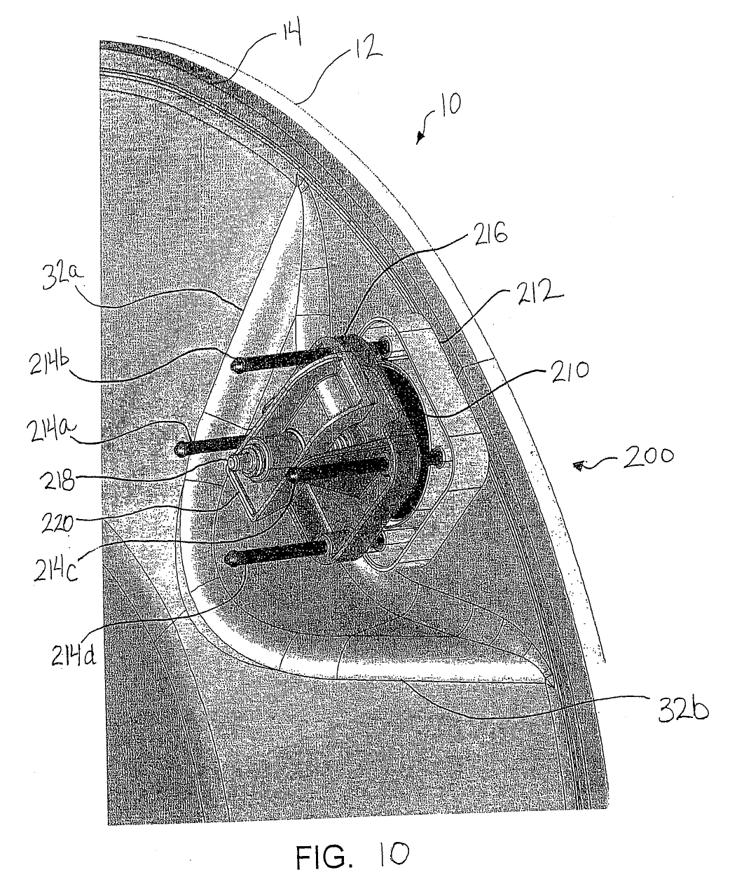

According to yet another embodiment, a snap retention assembly 300 is provided for retaining a cover over an opening. As shown in FIGS. 11 and 12, snap retention assembly 300 includes a living hinge member 310, having two support elements 312a, 312b, and a latch member 315 having a retaining end 314 and an actuation end 316. As shown in FIGS. 13, 14 and 16, snap retention assembly 300 also includes an actuator, such as but not limited to removable handle 328, which is adapted to engage actuation end 316 of latch member 315 to disengage retaining end 314 from an edge of the opening. As shown in FIGS. 12 and 14-16, actuation end 316 may include a hook portion.

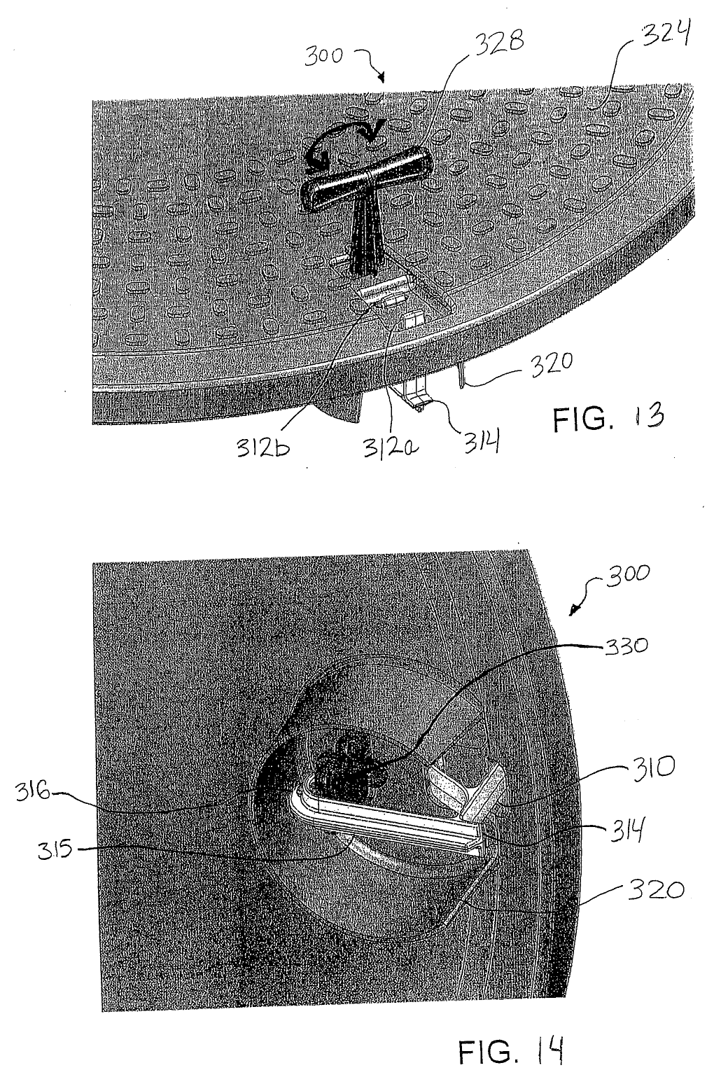

As shown in FIGS. 12, 15 and 16, support elements 312a, 312b function to connect snap retention assembly 300 to a cover such as manhole cover 324, such as by a snap connection or the like. Retaining end 314 of latch member 315 selectively engages an edge or lip portion of opening 326. Thus, living hinge member 310 functions to connect cover 324 to an edge of opening 326. Latch member 315 of living hinge member 310 is biased in a latched position. Accordingly, an actuator is provided to engage and displace actuation end 316, which disengages retaining end 314 from opening 326. When retaining end 314 is disengaged from opening 326, cover 324 may be released from opening 326. As shown in FIGS. 17, 18 and 20, the actuator may include a removable handle 328. As shown in FIGS. 14 and 16, removable handle 328 may include cross members 330 which engage actuation end 316 when removable handle 328 is turned or rotated. As best shown in FIG. 16, engagement of actuation end 316 by cross members 330 causes retaining end 314 to move away from the edge of opening 326, such that retaining end 314 is disengaged from opening 326. Manhole cover 324 may then be lifted and removed from opening 326.

As shown in FIGS. 11, 12 and 15, a covering element 322 may be provided to prevent dirt or other debris from entering the aperture or apertures in manhole cover 324, which may be provided for snap retention assembly 300. Covering element 322 may be secured to cover 324 by a snap connection or the like.

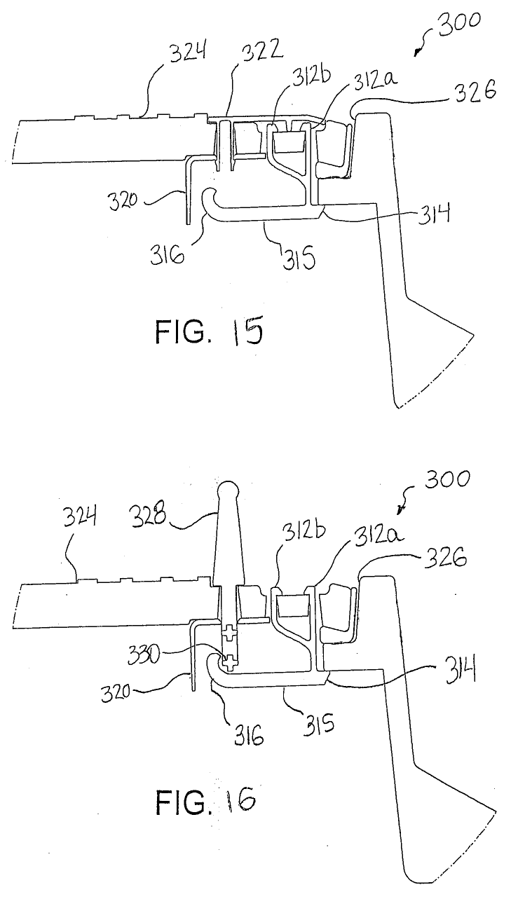

As shown in FIGS. 11-16, a cup element 320 may be included to protect or shield the portions of snap retention assembly 300 that are positioned below the cover, including portions of living hinge 310 and the actuator, such as removable handle 328. For example, as best shown in FIGS. 15 and 16, cup element 320 may protect actuation end 316 from being inadvertently moved or shifted, which may prevent retaining end 314 from being inadvertently disengaged from the edge of opening 326. Optionally, cup element 320 may be secured by a snap connection or the like to either covering element 322 (FIG. 15) or removable handle 328 (FIG. 16).

Optionally, snap retention assembly 300 may be formed from a reinforced polymer or resin, as discussed above. Also, snap retention assembly 300 may be used to latch or otherwise secure a cover that is formed from a polymer.

Thus, the various embodiments provide a low-cost and lightweight clamping, sealing, locking or snap retention devices for a manhole cover or manhole cover assembly. The various embodiments may prevent unauthorized access to a manhole and allow a manhole cover to be sealed at the opening which it is covering, to prevent water or other matter from leaking through the opening. Further, when covering a sewer, a sealed manhole cover may prevent water or other matter from entering the sewer and combining with sewage, thus reducing the total amount of sewage to treat. A sealed manhole cover may also keep dust and debris and moisture from fiberoptic areas.

Changes and modifications to the specifically described embodiments may be carried out without departing from the principles of the present invention, which is intended to be limited only by the scope of the appended claims as interpreted according to the principles of patent law including the doctrine of equivalents.

1. A screw cap assembly for clamping a cover in an opening, said screw cap assembly comprising:
a threaded rod adapted to engage the cover;
a clamp threadably connected to said threaded bolt;
a retainer for supporting said threaded rod, wherein said retainer includes first and second abutments adapted to engage said clamp to limit the range of movement of said clamp;
wherein rotational movement of said threaded rod causes said clamp to rotate about said threaded rod and travel toward the cover until said clamp engages said first abutment, said first abutment adapted to prevent further rotational movement of said clamp; and
wherein rotational movement of said threaded rod in an opposite direction causes said clamp to rotate and travel and away from the cover until said clamp engages said second abutment, said second abutment adapted to prevent further downward movement of said clamp.

2. The screw cap assembly of claim 1, wherein said retainer is adapted to engage said threaded rod at two points along said threaded rod, wherein said clamp is threadably connected to said threaded rod between said two points.

3. The screw cap assembly of claim 1, wherein said first abutment is formed as a ridge along the surface of said retainer.

4. The screw cap assembly of claim 1, wherein said second abutment is formed as a

5. The screw cap assembly of claim 1, including a spring mounted to said threaded bolt, wherein said spring is biased to urge said clamp toward said second abutment of said retainer.

6. The screw cap assembly of claim 1, including a connection element adapted to support said threaded bolt at the cover.

7. The screw cap assembly of claim 6, including a nut threadably connected to said connection element for retaining said connection element to said retainer.

8. The screw cap assembly of claim 1, wherein said clamp includes an aperture, said threaded rod being positioned through said aperture in said clamp.

9. The screw cap assembly of claim 1, wherein said retainer includes at least two extensions adapted to at protect said threaded rod and said clamp.

10. The screw cap assembly of claim 1, wherein said screw cap assembly is formed from a polymer.

11. The screw cap assembly of claim 1, wherein the cover comprises one chosen from a unitary manhole cover and manhole cover assembly having at least two components.

12. The screw cap assembly of claim 11, wherein the cover is formed from a polymer.

13. The screw cap assembly of claim 1, wherein said clamp creates a sealed connection between the cover and the opening.

14. The screw cap assembly of claim 1, wherein said clamp includes a flanged edge adapted to engage a structure adjacent to the opening.

15. A screw cap assembly for clamping a cover in an opening, said screw cap assembly comprising:
a cap adapted to be positioned at an aperture in the cover;
a retainer adapted to secure said cap in said aperture in the cover;
at least one tie rod, said at least one tie rod connected to said retainer;
a traveling member connected to said at least one tie rod, wherein movement of said traveling member is guided by said at least one tie rod;
a threaded bolt having a head, said head engaging said cap, said threaded bolt threadably engaging said traveling member, wherein rotation of said threaded bolt in one direction causes upward movement of said traveling member;
a clamp connected to said traveling member, said clamp having an aperture, wherein said upward movement of said traveling member causes said threaded bolt to engage said aperture of said clamp, said threaded bolt causing said clamp to pivot toward the opening until said clamp engages the opening; and
wherein rotation of said threaded bolt in an opposite direction causes downward movement of said traveling member, said downward movement causing said threaded bolt to disengage said aperture in said clamp, wherein said clamp may pivot away from the opening to release the cover from the opening.

16. The screw cap assembly of claim 15, wherein said traveling member is snapped onto said at least one tie rod.

17. The screw cap assembly of claim 15, wherein said clamp is snapped onto said traveling member.

18. The screw cap assembly of claim 15, wherein said clamp creates a sealed connection between the cover and said opening.

19. The screw cap assembly of claim 15, wherein said screw cap assembly is formed from a polymer.

20. A snap retention assembly for retaining a cover in an opening, said snap retention comprising:
a living hinge member having two support elements and a latch member, wherein said support elements are fastened to said cover, said latch member having a retaining end and an actuation end, wherein said retaining end is adapted to engage an edge of said opening, wherein said latch member is biased in a latched position; and
an actuator adapted to engage said actuation end of said latch member to disengage said retaining end from said edge of said opening.

21. The snap retention assembly of claim 20, wherein a cup element is adapted to protect a portion of said living hinge member and a portion of said actuator positioned below the cover.

22. The snap retention assembly of claim 20, said actuator comprising a removable handle having at least one cross member adapted to engage said actuation end when said removable handle is turned.

23. The snap retention assembly of claim 20, wherein a covering element is positioned at an upper surface of said cover, said covering element adapted to cover at least one aperture in the cover.

24. The snap retention assembly of claim 20, wherein said support elements of said living hinge member are snapped onto the cover.

25. The snap retention assembly of claim 20, wherein said snap retention assembly is formed from a polymer.
